(19) United States
(12) Patent Application Publication
(10) Pub. No.: US 2006/0230236 A1
(43) Pub. Date: Oct. 12, 2006

(54) Method and apparatus for precognitive fetching

(75) Inventors: Sheldon J. Finkelstein, Los Altos Hills, CA (US); Srinivasan Viswanathan, Fremont, CA (US); Robert Charles Zak JR., Bolton, MA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/102,339

(22) Filed: Apr. 8, 2005

(51) Int. Cl. G06F 12/00

(52) U.S. Cl. 711/137

(57) ABSTRACT

A method for precognitive fetching, involving receiving an original request, performing pre-fetching analysis using the original request to obtain a pre-fetch request, forwarding the pre-fetch request to a storage subsystem, and receiving a response to the pre-fetch request from the storage subsystem.

### BACKGROUND

The performance of storage subsystems is dependent on the distance between the storage subsystems and microprocessors. The closer that the storage subsystem is to the processor, the quicker the data and resources needed from storage are brought in from storage for use by the processor. However, it is not possible to fit entire storage subsystems close to processors that execute requests.

Thus, a large gap has been created between the performance of microprocessors and storage subsystems. As a result, when several requests are being processed by multi-processor systems, retrieving resources and/or data from storage in response to these numerous requests typically causes overall performance degradation.

Conventionally, memory management techniques, such as the use of caches have reduced this performance gap. A cache is typically high speed memory that allows data to be stored close to the processor and reduces the time/distance necessary to fetch the data and execute the requests. However, in some application domains, caches have limited benefits. For example, any application domain that does not frequently re-use data would not benefit from the data stored in the cache. Cache misses (i.e., an unsuccessful attempt to satisfy a request using a cache) significantly decrease performance because when data is not found in the cache, the request for the data is sent to additional levels of the memory hierarchy, e.g., storage, main memory, etc. Accessing storage/main memory typically takes a significant amount of time (i.e., milliseconds versus nanoseconds).

Data pre-fetching is a memory management technique that may be used to overcome the latencies associated with cache misses. Data pre-fetching is a method of hinting resource use to the storage subsystem. Specifically, data pre-fetching is similar to instruction pipelining, where instructions are loaded into registers ahead of time. Data pre-fetching involves making an attempt to fetch resources into cache in response to requests before the resources are actually referenced.

### SUMMARY OF INVENTION

In general, in one aspect, the invention relates to a method for precognitive fetching, comprising receiving an original request, performing pre-fetching analysis using the original request to obtain a pre-fetch request, forwarding the pre-fetch request to a storage subsystem, and receiving a response to the pre-fetch request from the storage subsystem.

In general, in one aspect, the invention relates to a system, comprising a plurality of processors located in a complex and configured to process an original request, a pre-fetch module configured to perform pre-fetching analysis on the original request to obtain a pre-fetch request, send the pre-fetch request to a storage subsystem, and send the original request to the plurality of processors, a storage subsystem operatively connected to the pre-fetch module and configured to generate a response to the pre-fetch request.

In general, in one aspect, the invention relates to a computer system for precognitive fetching, comprising a processor, a memory, a storage device, and software instructions stored in the memory for enabling the computer system under control of the processor, to receive an original request, perform pre-fetching analysis using the original request to obtain a pre-fetch request, forward the pre-fetch request to a storage subsystem, and receive a response to the pre-fetch request from the storage subsystem.

Other aspects of the invention will be apparent from the following description and the appended claims.

### BRIEF DESCRIPTION OF DRAWINGS

FIG. 1 shows a system for precognitive fetching in accordance with an embodiment of the invention.

FIG. 2 shows a flow chart for precognitive fetching in accordance with an embodiment of the invention.

FIG. 3 shows a computer system in accordance with an embodiment of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of embodiments of the invention, numerous specific details are set forth in order to provide a more thorough understanding of the invention. In other instances, well-known features have not been described in detail to avoid obscuring the invention.

In general, embodiments of the invention relate to precognitive fetching of resources from storage. More specifically, embodiments of the invention relate to performing pre-fetching analysis on one or more requests to determine which resources to strategically transfer from the storage subsystem to memory shared by processors (e.g., cache). Further, embodiments of the invention relate to placing pre-fetched resources into a shared cache for a processor that, based on pre-fetching analysis, may require the resources during execution.

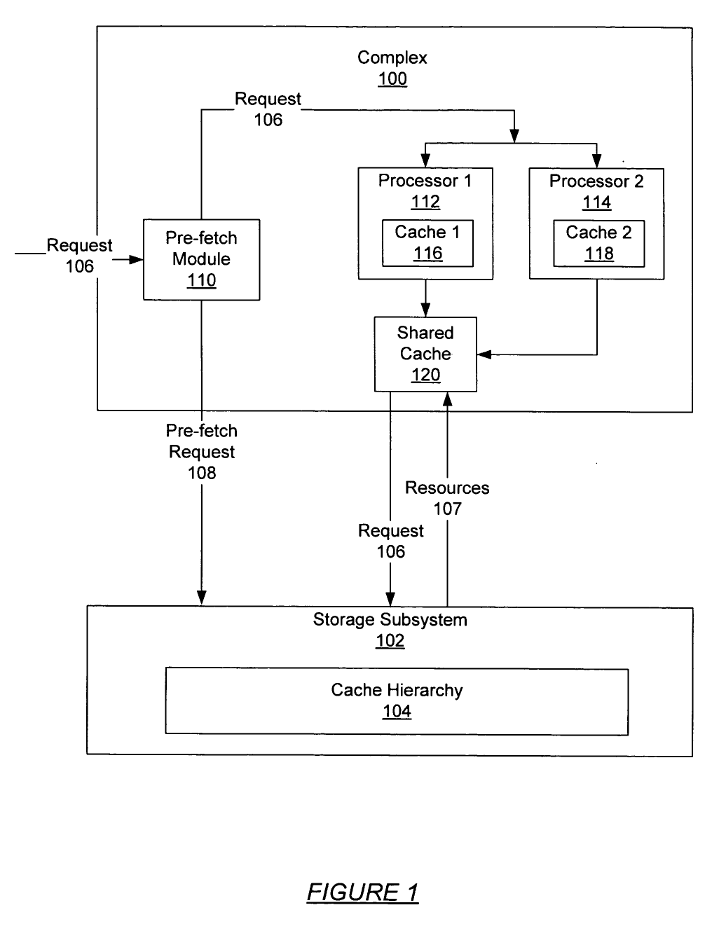

FIG. 1 shows a system for precognitive fetching in accordance with one embodiment of the invention. The system shown in FIG. 1 includes a complex (100), a storage subsystem (102), and a pre-fetch module (110).

In one embodiment of the invention, the complex (100) may be any collection of processing units (e.g., Processor 1 (112), Processor 2 (114)) that share a network and storage system (i.e., memory hierarchy). For example, the complex (100) may be a computer system, a server, a distributed network, etc.

Further, in one embodiment of the invention, the complex (100) may be generalized to a distributed environment with a collection of complexes. In one embodiment of the invention, the processors (e.g., Processor 1 (112), Processor 2 (114)) may each include one or more on-board cache (e.g., Cache 1 (116) and Cache 2 (118)), which, depending on the caching technique being employed, may store resources most recently accessed by the processor associated with the on-board cache. The complex (100) also includes shared cache (120), which is another sort of cache that is shared by the processor(s) (e.g., Processor 1 (112), Processor 2 (114)) located on the complex (100), as discussed below. In one embodiment of the invention, a pre-fetch module (110) (as discussed below) may be located on the complex to receive a request (106), perform pre-fetch analysis on the request, and forward appropriate requests to a processor and storage.

Those skilled in the art will appreciate that although the pre-fetch module (110) is shown in FIG. 1 as residing in the complex (100), the pre-fetch module (110) may reside anywhere in the system, provided that the pre-fetch module is able to acquire data that would be required for processing requests and issue the requests to storage (i.e., the pre-fetch module may detect for requests whose destination is the complex and service these requests). Thus, for example, in one embodiment of the invention, the network may decide if a received request (106) needs to be sent to the storage subsystem (102), based on the type of the request (106), and subsequently, the pre-fetch module (110) (and pre-fetch analysis) may be located at the storage subsystem (102) level. Further, in one embodiment of the invention, the pre-fetch module (110) may reside in a remote location (i.e., remote from the complex) or be distributed as multiple instances across the network. In this case, the pre-fetch module may perform remote fetching for resources, such as pre-fetching of a non-local file that is part of a global file system.

Further, as noted above, the pre-fetch module (110) includes functionality to send the request (106) (i.e., the original request received from the network) to a processor (e.g., Processor 1 (112), Processor 2 (114)) that is capable of executing the request (106). In one embodiment of the invention, if the complex (100) is a multi-processor system, then the pre-fetch module (110) may place the request (106) in a queue (not shown) for any available processor to obtain. Alternatively, the complex (100) may include only one processor, in which case the pre-fetch module (110) may send the request (106) directly to the processor. Further, in one embodiment of the invention, the processors (Processor 1 (112), Processor 2 (114)) include functionality to handle multiple requests. In one embodiment of the invention, a request queue (not shown) exists within the processor, which is responsible for queuing requests to be handled by that particular processor.

Referring back to FIG. 1, precognitive fetching, in one embodiment of the invention, involves analyzing an original request (106) (i.e., a request received from a network, hereinafter referred to as a “request”) to determine which resources (107) from a storage subsystem (102) (if any) may be necessary to provide in a response to the original request (106). In one embodiment of the invention, the response to a request is defined as moving resources necessary to execute the request closer to the processor executing the request. The resources (107), which may include a complete or a partial response to the request (106), are subsequently retrieved from memory and used by a processor (e.g., Processor 1 (112), Processor 2 (114)) to process the request (106). In one embodiment of the invention, the request (106) analyzed in the present invention include short discrete requests, such as a business transaction request, a Java™2 Platform Enterprise Edition (J2EE) request, a service request, etc. Further, resources (107) transferred from a storage subsystem (102) may include, for example, data, code, code packages that are part of a service that includes components that may be deployed and operate in different locations, code that may be dependent on other portions of code, or any other information associated with the request (106). In one embodiment of the invention, the resources (107) may be part of a response to a request (106), or a complete response to a request (106).

In one embodiment of the invention, the resources (107) that are deemed responsive to a request (e.g., request (106), a pre-fetch request (108), etc.) are transferred from the storage subsystem (102) and placed in shared cache (120). In one embodiment of the invention, the shared cache (120) may be located at any place in a system that may be accessed by one or more processors (e.g., Processor 1 (112), Processor 2 (114)). The shared cache (120) allows any processor handling a particular request (106) to obtain the necessary resources (107) without the need for the time-consuming access to the storage subsystem (102). Thus, moving the resources (107) needed to execute a request (106) from a lower level in the storage hierarchy to a higher level in the storage hierarchy and into the shared cache (120) before a processor services the request (106) greatly increases the performance of a system where the shared cache is heavily accessed. Those skilled in the art will appreciate that resources may be moved from remote locations to a closer node that may or may not be part of the complex (100).

Alternatively, the processor may use the on-board cache (e.g., Cache 1 (116), Cache 2 (118)) within the processor to obtain information to execute the request (106) if the information is already present in the processor's local cache (e.g., Cache 1 (116), Cache 2 (118)). In this case, a network load balancer may exist that is capable of understanding which instance of a processor or processing unit in the complex can handle the request. Thus, if an affinity is determined for a request to be processed at a particular component of the complex, then the request may be handled by the particular component, and this information may be obtained from a processor's local cache (e.g., Cache 1 (116), Cache 2 (118)).

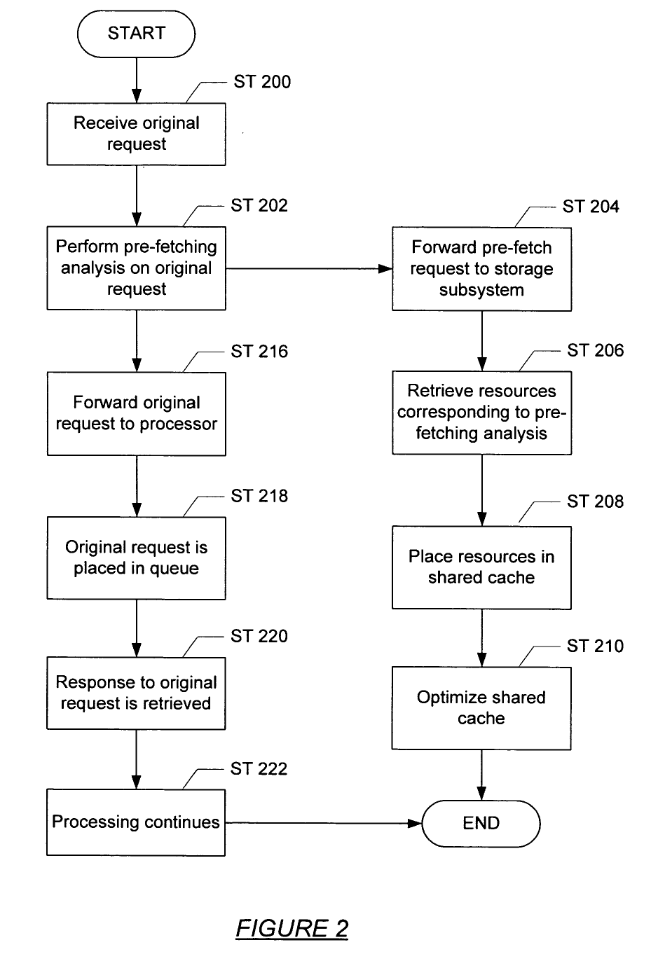

As described above and shown in FIG. 1, the complex (100) includes a pre-fetch module (110) responsible for performing pre-fetching analysis. More specifically, in one embodiment of the invention, the pre-fetch module (110) includes functionality to receive requests (106) from the network and perform pre-fetching analysis using the request (106) (discussed below in FIG. 2). The pre-fetch module (110) may be a network component, a processor, a pre-processor, a software module, or any other component capable of performing analysis using a request (106). Accordingly, the use of the term “module” is not intended to be limited to a physical component and one skilled in the art can appreciate that the pre-fetch module may take many different forms. Further, in one embodiment of the invention, the pre-fetch module (110) includes functionality to send a pre-fetch request (108) to the storage subsystem (102). The pre-fetch request (108) is a request for resources (107) that is sent to the storage subsystem (102) based on the pre-fetching analysis performed using the request (106). Additionally, the pre-fetch module (110) sends the request (106) received from the network to a processor (e.g., Processor 1 (112), Processor 2 (114)). Further, in one embodiment of the invention, the pre-fetch module may perform a remote external data access to obtain resources that may be moved within the storage subsystem so that the resources are closer to a processor.

In one embodiment of the invention, the storage subsystem (102) as shown in FIG. 1 is a large portion of memory used to store the resources (107) necessary to respond to and execute requests. In one embodiment of the invention, the storage subsystem (102) may include a cache hierarchy (104). The cache hierarchy (104) enables frequently accessed information to be in closer proximity to the processor (e.g., Processor 1 (112), Processor 2 (114)) by placing caches in a hierarchical structure of the storage subsystem (102). For example, the cache hierarchy (104) may include disk drives at the bottom of the cache hierarchy (104), a database cache in the intermediate level of the cache hierarchy (104), and an entry cache at the top of the cache hierarchy (104). Thus, frequently accessed information may be placed in the entry cache (i.e., higher level), while information that is less frequently accessed may be stored at the disk drive level of the hierarchy (i.e., lower level). In one embodiment of the invention, the cache hierarchy (104) shown in FIG. 1 may function as the shared cache (120). In this case, all the resources (107) deemed responsive to the pre-fetch request (108) from the storage subsystem (102) may be placed in the top cache of the cache hierarchy (104). In this manner, processors (e.g., Processor 1 (112), Processor 2 (114)) may obtain the response to the request (106) from the cache hierarchy (104).

The storage subsystem (102) includes functionality to handle multiple requests for the same information that may be sent from both a processor (e.g., Processor 1 (112), Processor 2 (114)) and the pre-fetch module (110). For example, if the pre-fetch module (110) performs pre-fetching analysis using a request (106), and subsequently forwards the pre-fetch request (108) to the storage subsystem (102), a request (106) for the same resources (107) may also be sent to the storage subsystem (102) by the processor executing that particular request (106) or a related request (106). The storage subsystem (102) is able to resolve any resulting conflicts in a manner known in the art.

FIG. 2 shows a flow chart for precognitive fetching in accordance with one embodiment of the invention. Initially an original request is received into the pre-fetch module (described above) from the network (Step 200). Subsequently, the pre-fetch module performs pre-fetching analysis using the original request (Step 202). In one embodiment of the invention, several ways to perform pre-fetching analysis using the original request may exist. For example, as discussed below, pre-fetching analysis may be implemented by performing data mining, such as request mining and response mining.

In one embodiment of the invention, request mining involves generalizing requests received by the pre-fetch module across a series of transactions. Specifically, request mining includes analyzing requests to find patterns among current and future requests to determine a relationship between a particular request and resources associated with the request. The patterns found among groups of requests may then enable the pre-fetch module to determine which resources are necessary for current and future requests. For example, consider the scenario where a particular request received by the pre-fetch module is a business transaction request involving a customer purchasing an item at a hardware store, e.g., Joe's Hardware. In this case, the request received by the pre-fetch module may include identifiers for the type of request (i.e., a business transaction request), the name of the request (i.e., a purchasing request), the name of the store (i.e., Joe's Hardware), etc., which may be located in the header, envelope, or body of the request. Those skilled in the art will appreciate that if identifiers are located in the body of the request, the information may be either unencrypted or decrypted by system components that may be part of the pre-cognitive analysis. These identifiers are used to perform request mining (i.e., determine what types of additional resources may potentially be needed to execute the particular request). Based on these identifiers associated with the request, the pre-fetch module is able to determine that the resources necessary to execute the request may also include business transaction information for the particular customer that frequents the store. Thus, the resources fetched from storage may also include the customer's credit card information, name, identification number, etc.

Further, those skilled in the art will appreciate that, based on pre-fetching analysis using request mining, identification of one resource associated with a business transactions may trigger other resources to also be obtained from the storage subsystem. For example, if a particular customer shops at Joe's Hardware regularly, than a credit card payment made by the customer may result in pre-fetch requests for subsequent transactions or additional customers on the same date based on the pattern of requests obtained using request mining. Specifically, retrieving the customer name as part of the resources needed for a request may lead to other information regarding the particular customer, the particular date, or particular transaction being accessed, e.g., accessing the customer name may also lead to the formulation of a pre-fetch request to retrieve a list of items typically purchased by the customer, other customers using a credit card at the store on a particular date, etc.

Those skilled in the art will appreciate that pre-fetching analysis using any method may be incomplete or may include data that is unnecessary. For example, incomplete resources may be moved higher in the storage hierarchy, or excess resources that are unnecessary to execute a request may be retrieved from the storage hierarchy. In either case, intelligent cache management strategies may be employed to remove unnecessary information from high levels of the storage hierarchy or to bring in resources missing for a particular request (described below).

As noted above, data mining may also include response mining. Response mining involves analyzing the response from the storage system (i.e., the resources retrieved from the storage subsystem; rather than requests from the network) to determine any patterns between the request received and the type of resources placed into the shared cache from the storage subsystem. Using the same example from above, response mining may involve predicting a sequence of requests for items purchased by the customer using the resources retrieved from the storage subsystem. Specifically, if credit card information is retrieved as resources from the storage subsystem for a customer shopping at Joe's Hardware, then response mining analysis may determine that subsequent requests associated with that customer require a customer identification number or a list of items purchased by the customer, or credit card information for other customers on the same date, etc. Based on this sequence of events, a pre-fetch request for relevant additional resources may be formulated.

Alternatively, pre-fetching analysis shown in Step 202 of FIG. 2 may involve program analysis. In one embodiment of the invention, program analysis involves analyzing the actual code associated with the request. Specifically, continuing with the business transaction example, the business transaction is typically realized as some code contained in the request received by the pre-fetch module. The code that realizes the particular business transaction is executed on the processor. This code may be analyzed to determine which resources may be associated with the request. For example, program analysis may involve analyzing branch statements in the code to determine which branches in the code are frequently executed and which branches are rarely executed based on the values of variables and the statements used in the program. In this manner, the analysis may determine which services associated with the request may be invoked. Subsequently, such program information may be used to determine what resources are needed from the storage subsystem based on the path of the code that is traced, and a pre-fetch request for these resources could be formulated to trigger once a path is taken.

Those skilled in the art will appreciate that program analysis may not be performed at execution time (i.e., during the execution of the request), although the possibility of performing program analysis at execution time exists. Rather, program analysis is performed before execution of the request. Further, those skilled in the art will appreciate that several other aspects of the code may be analyzed to determine information associated with the request. Again, those skilled in the art will appreciate that in program analysis, the branches that may be executed may not be known at times, so some level of program analysis may be incomplete. However, as with typical programming flows, there are techniques well known in the art that may be used to infer or determine which parts of the program may be executed. Thus, program analysis is used to judge the resources that may be needed to service a request.

In one embodiment of the invention, another method that may be used to perform pre-fetching analysis as shown in Step 202 may involve manual analysis. Manual analysis involves a human being understanding a request enough to know what resources may be need to be pre-fetched. Thus, manual analysis involves pre-fetching resources that are specified by a human. For example, if a customer performs a credit card transaction at Joe's Hardware, input would be required from a system user to specify the resources to gather from the storage subsystem based on the user's knowledge of the system, e.g., customer zip code, credit card security code, etc.

Those skilled in the art will appreciate that the business transaction request example used to illustrate the different pre-fetching analysis options is not meant to limit the invention in any way. Moreover, requests may be any type, e.g., short, discrete requests such as J2EE requests, service requests, session-state transaction requests, etc, in which case the pre-fetching analysis performed would not involve a business transaction. For example, a service request may involve obtaining a particular service as a resource. The service may be located on a remote web server or elsewhere on the network. In this case, the pre-fetching analysis may lead to resources retrieved remotely. Alternatively, in one embodiment of the invention, a request may be associated with a session-state transaction. For example, a transaction may be associated with a session ID, where different session states correspond to the continued execution of a transaction. Upon knowing the session ID, the pre-fetch module may use the session ID to fetch information for a previous state of the on-going request, or a future state of the on-going request. In one embodiment of the invention, the session-state transaction request may apply to pre-fetching resources for the execution of code.

In addition, in one embodiment of the invention, pre-fetching analysis may involve obtaining program code necessary to execute the request. Specifically, with respect to a request, the program (i.e., code to execute) and the data to execute the request may be pre-fetched. In one embodiment of the invention, program code may include code that is dependent on previously pre-fetched or already available program code. For example, one portion of program code may invoke another portion of program code, or one service may invoke another service. In other words, because code may use other code to execute a request, pre-fetching analysis may involve analyzing how to obtain dependent pieces of program code.

Returning to FIG. 2, once the pre-fetching analysis is performed using the original request, the pre-fetch module sends a pre-fetch request (formulated as described above) for resources to the storage subsystem (Step 204). In one embodiment of the invention, the storage subsystem retrieves the resources corresponding to the pre-fetching analysis (Step 206). Subsequently, the storage subsystem may place the resources in the shared cache (Step 208), which may be at the storage subsystem level (i.e., in the form of a cache hierarchy (104) in FIG. 1) or at the processor level (i.e., shared cache (120) in FIG. 1). In one embodiment of the invention, if the shared cache is full when the storage subsystem attempts to place resources in the shared cache, then intelligent cache management policies may be used to manage the shared cache. (Step 210). This optimization involves swapping data that is unused or infrequently needed by the processor with the current resources brought in from the storage subsystem. Typically, cache management based on some policy e.g., least recently used, swapping data that has not been used since the last pass through the shared cache, etc. Those skilled in the art will appreciate that cache management policies and managing shared caches is well known in the art.

In one embodiment of the invention, in addition to sending a pre-fetch request to the storage subsystem, the pre-fetch module sends the original request to the complex (or a shared processor queue) (Step 216). Those skilled in the art will appreciate that the requests may be sent to the storage subsystem (in Step 204) and the processor (in Step 216) at any time (i.e., the request may be sent in parallel, separately, precisely at the same time, or different times). As noted above, upon receipt of the request, the processor may place the request in a queue awaiting execution (Step 218). At this point, a response to the request is retrieved (Step 220). In one embodiment of the invention, Step 220 is performed using data/storage access procedures (i.e., operations for satisfying requests) well known in the art. Optimally, the present invention attempts to fetch the necessary information into shared cache from the storage subsystem before resources requested are needed by the processor. Thus, precognitive fetching may significantly improve performance of the system when handling requests (i.e., if resources fetched are not already in cache).

Initially, a search for the resources associated with the original request is performed in the local cache (e.g., L1 cache). Next, a shared cache (e.g., L2 cache) is searched. If the pre-fetch analysis described above is successful, the resources associated with the request is found in shared cache (e.g., shared cache (120) in FIG. 1) and retrieved. However, if the resources are not found in local cache or shared cache. (i.e., a cache miss occurs), then the processor sends the request to the storage subsystem, as usual. During this time, while the processor is waiting for the resources from the storage subsystem needed to continue processing, the processor may pull other requests from the queue and execute those requests. Thus, the processor includes functionality to continue executing requests while waiting for resources from the storage subsystem. Once the response is retrieved, processing continues (Step 222) (i.e., the processor executes the request, processes other requests, etc.). Those skilled in the art will appreciate that the aforementioned process used to execute requests is the typical way that processor(s) and storage subsystems operate.

In one embodiment of the invention, if the complex is generalized to a distributed environment with a collection of complexes, the location where pre-fetching analysis is performed may be arbitrary and collections of resources may be moved across complexes or within complexes. In other words, the complex destination may not be fixed for resources to be placed in a particular area. For example, resources may be moved to the code, code and some resources may be moved to a location where a larger portion of resources are located, resources may be moved to a location that has other necessary resources to execute requests (e.g., CPU cycles, memory, etc.) but no code or data. Thus, depending on the need for each request, the code to execute the request and the resources that are pre-fetched may be transferred from one location to another.

As mentioned above, those skilled in the art will further appreciate that pre-fetching analysis may be incomplete or may include data that is unnecessary. For example, pre-fetching analysis corresponding to a particular request may result in extra resources (i.e., more than necessary information) retrieved from the storage subsystem, filling up the shared cache with potentially unnecessary resources. On the other hand, the pre-fetching analysis may result in overly conservative resources obtained from the storage subsystem. In the first scenario, if unnecessary resources are brought into the shared cache, the extra resources are eventually intelligently managed from the shared cache when the shared cache is full. If incomplete resources (i.e., additional data is required for the request) are retrieved from the storage subsystem, then the request is sent further down the storage hierarchy as part of the attempt to retrieve the correct resources required to continue processing (assuming that the resources were not already located in the local cache or shared cache). Based on the actual results of the pre-fetching analysis, subsequent pre-fetching analysis may refine the resources that are retrieved from the storage subsystem. Throughout this process of refining resources, the processor continues processing requests by performing normal operations that are used to satisfy requests.

In one embodiment of the invention, the pre-fetch module may be unaware whether all the resources needed for a particular request are available to retrieve from the storage subsystem. For example, consider the scenario in which a database request is received by the pre-fetch module, which requires the pre-fetch module to retrieve resources that include a variety of data (i.e., resources that are not unique values). More specifically, consider the example in which a database request requires information regarding a class of information, such as all the female employees of a company. To pre-fetch information to honor this type of request, the pre-fetch module determines whether or not the set of information (i.e., the set of employees that are female, or the gender of all the employees at the company) exists. In this case, a descriptor describing what is contained in the database may be required. The set of information may be updated frequently or may not be available at the particular instance in time that the pre-fetch module needs to retrieve the information. In one embodiment of the invention, the pre-fetch module may pre-fetch a version of the set of information that may not be correct or may be previously correct but recently changed.

Furthermore, the processor may complete a request before the resources corresponding to pre-fetching analysis are retrieved. For example, a processor may send an original request to the storage subsystem and receive a response before the storage subsystem (responding to the pre-fetch request) places resources into the shared cache.

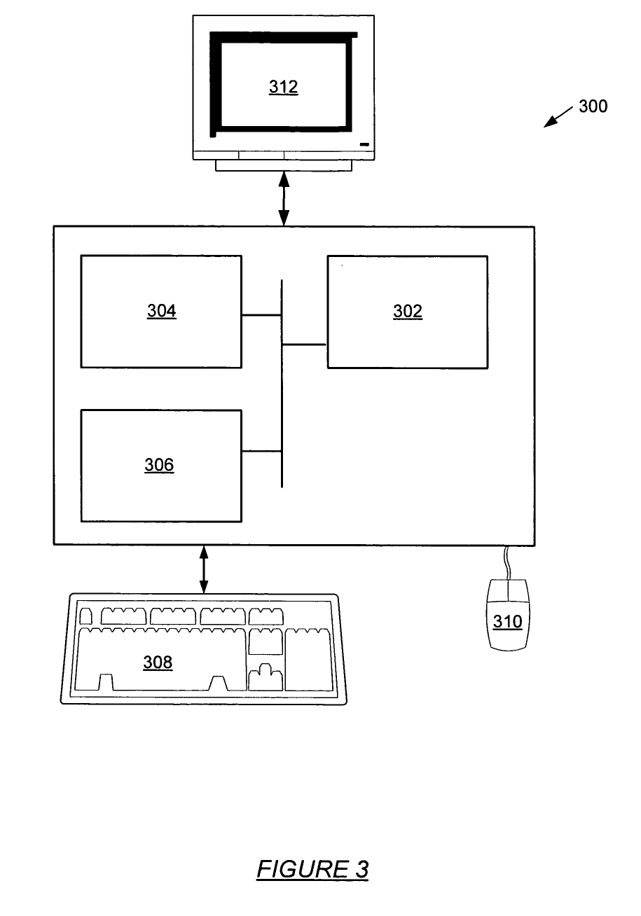

One or more embodiments of the invention may be implemented on virtually any type of computer regardless of the platform being used. For example, as shown in FIG. 3, a networked computer system (300) includes a processor (302), associated memory (304), a storage device (306), and numerous other elements and functionalities typical of today's computers (not shown). The networked computer (300) may also include input means, such as a keyboard (308) and a mouse (310), and output means, such as a monitor (312). The networked computer system (300) is connected to a local area network (LAN) or a wide area network via a network interface connection (not shown). Those skilled in the art will appreciate that these input and output means may take other forms. Further, those skilled in the art will appreciate that one or more elements of the aforementioned computer (300) may be located at a remote location and connected to the other elements over a network. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for precognitive fetching, comprising:
receiving an original request;
performing pre-fetching analysis using the original request to obtain a pre-fetch request;
forwarding the pre-fetch request to a storage subsystem; and
receiving a response to the pre-fetch request from the storage subsystem.

2. The method of claim 1, further comprising:
placing the response to the pre-fetch request in a shared cache, wherein the shared cache is located in a complex.

3. The method of claim 2, further comprising:
performing intelligent cache management policies for the shared cache if the shared cache is full.

4. The method of claim 2, wherein the response comprises resources associated with the pre-fetch request, wherein the resources are moved within the storage subsystem and placed closer to the complex.

5. The method of claim 4, wherein resources comprise at least one selected from the group consisting of data, code packages, services, and program code.

6. The method of claim 2, wherein the storage subsystem comprises the shared cache.

7. The method of claim 2, wherein a processor obtains the response from the shared cache.

8. The method of claim 1, further comprising:
forwarding the original request to a complex.

9. The method of claim 8, further comprising:
queuing the original request for processing by the processor within the complex.

10. The method of claim 1, further comprising:
executing the original request using the response.

11. The method of claim 1, wherein the storage subsystem comprises a cache hierarchy configured to function as a shared cache.

12. The method of claim 1, wherein pre-fetching analysis comprises one selected from the group consisting of a program analysis, a data mining analysis, and a manual analysis.

13. The method of claim 12, wherein the data mining analysis comprises one selected from the group consisting of request mining and response mining.

14. The method of claim 1, wherein the original request is a short and discrete request.

15. The method of claim 1, wherein the original request is one selected from the group consisting of a session-state transaction request, a code package request, a database request, and a J2EE request.

16. A system, comprising:
a plurality of processors located in a complex and configured to process an original request;
a pre-fetch module configured to:
perform pre-fetching analysis on the original request to obtain a pre-fetch request,
send the pre-fetch request to a storage subsystem, and
send the original request to the plurality of processors;
a storage subsystem operatively connected to the pre-fetch module and configured to generate a response to the pre-fetch request.

17. The system of claim 16, wherein the pre-fetch module comprises software analysis capability that may be executed across one selected from the group consisting of a network, a storage subsystem, a remote system.

18. The system of claim 16, further comprising:
a shared cache operatively connected to the plurality of processors and configured
to store the response to the pre-fetch request.

19. The system of claim 16, wherein the plurality of processors obtain the response from the shared cache.

20. The system of claim 16, wherein the storage subsystem comprises a cache hierarchy configured to function as a shared cache.

21. The system of claim 16, wherein pre-fetching analysis comprises one selected from the group consisting of a program analysis, a data mining analysis, and a manual analysis.

22. The system of claim 21, wherein the data mining analysis comprises one selected from the group consisting of request mining and response mining.

23. The system of claim 16, wherein the request is a short, discrete request.

24. The system of claim 16, wherein the response comprises resources associated with the pre-fetch request.

25. The system of claim 24, wherein resources comprise at least one selected from the group consisting of data, code packages, services, and program code.

26. The system of claim 16, wherein the complex is part of a distributed environment comprising a plurality of complexes.

27. A computer system for precognitive fetching, comprising:
a processor;
a memory;
a storage device; and
software instructions stored in the memory for enabling the computer system under control of the processor, to:
receive an original request;
perform pre-fetching analysis using the original request to obtain a pre-fetch request;
forward the pre-fetch request to a storage subsystem; and
receive a response to the pre-fetch request from the storage subsystem.
